(19) United States
(12) Patent Application Publication
(10) Pub. No.: US 2004/0134735 A1
(43) Pub. Date: Jul. 15, 2004

(54) Modular constructed multifunctional system, particularly a combined drive, brake and power transfer system

(76) Inventors: Werner Klement, Heidenheim (DE); Klaus Vogelsang, Crailsheim (DE); Reinhard Kernchen, Satteldorf (DE); Karl-Heinz Diele, Satteldorf-Ellrichshausen (DE); Martin Becke, Ulm (DE)

Correspondence Address: BAKER & DANIELS, 111 E. WAYNE STREET, SUITE 800, FORT WAYNE, IN, 46802

(21) Appl. No.: 10/476,279

(22) PCT Filed: Apr. 24, 2002
(86) PCT No.: PCT/EP02/04493

(30) Foreign Application Priority Data
Apr. 30, 2001 (DE) 101 21 148.1

(51) Int. Cl. F16D 33/00

(52) U.S. Cl. 192/3.32; 192/3.23; 192/13 R; 192/48.92

(57) ABSTRACT

The invention relates to a modular constructed multifunctional system. According to the invention, the modular constructed multifunctional system is endowed with the following characteristics: an input (E) and an output (A); a drive element (2) in the form of a hydrodynamic element (3), comprising a drive side (6) which can be coupled in a torsion-proof manner to the input, and a driven side (7) coupled to the output and at least one primary wheel and a secondary wheel (9); a switchable coupling (5) between the input and the output; a free wheel (F) arranged between the driven side of the drive element and the output; a brake device (13) for stationary support and braking of the secondary wheel on a housing (15); the switchable coupling is embodied in the form of a running friction coupling; a drive element, a braking element and a free wheel are incorporated into a modular unit.

The invention relates to a modular constructed multifunctional system for use in transmissions, particularly automatic and automated gear shift mechanisms, particularly combined drive, brake and power transfer system in particular with characteristics from the generic term of Claim 1; further a transmission component.

Transmissions for use in vehicles, particularly commercial vehicles in the form of gear shift mechanisms are known in a multitude of different designs. As a rule what they have in common is the fact that the starting procedure is achieved by means of a clutching device in the form of a friction coupling or a hydrodynamic transformer. However, the use of a friction coupling as a drive element becomes problematic in the operational states which are characterized by an increased slippage over a longer period of time. This holds especially true for the starting procedure. Due to the tremendous thermal load the clutching device is then subjected to an increased wear and tear. To keep this wear and tear as low as possible, corresponding requirements are to be placed on the friction lining to be used. In addition, the manifestations of wear and tear cause low service lives for the drive element. The disadvantage of solutions with drive elements in the form of hydrodynamic transformers consists essentially in the high costs for the hydrodynamic part and the requirement to provide a separating clutch.

A design of a transmission component with a drive element in the form of a hydrodynamic clutch is known from the publication DE 196 50 339 A1. At least two operating states are realized with this transmission component—a first operating state for power transmission in at least one switch step and a second operating state for braking. In the process, both functions are achieved via the elements of the hydrodynamic clutch, which therewith acts as a generic multifunctional unit. This comprises a primary wheel and a secondary wheel, which together form a toroidal working space. The realization of the function of a hydrodynamic retarder occurs by means of allocation of the function of the stator blade wheel, either by means of fixing opposite a resting transmission part to the primary wheel and of the function of the rotor blade wheel to the secondary wheel or by means of allocation of the function of the stator blade wheel to the secondary wheel by means of fixing of the secondary wheel opposite the resting driving gears and the function of the rotor blade wheel to the primary wheel. The blade wheel assuming the function of the rotor blade wheel is in both cases coupled with the transmission outlet shaft via the mechanical driving gear. The connection of the hydrodynamic clutch to the drive shaft or the mechanical driving gear of the transmission component occurs in such a way, that for realization of the first operating state the secondary wheel is connectable with the mechanical driving gear and the primary wheel with the drive primary shaft, while to achieve the second operation, i.e. braking, one of the two blade wheels is locked. To this purpose means for locking and decoupling of the drive strand are allocated to the hydrodynamic clutch, in particular to a blade wheel. This model allows the design of an especially compact transmission component, since a separate brake element can be dispensed with. However, one disadvantage of this model consists in the fact that this model is only designed for automatic gear shift mechanisms, with which during the shifting operation the motor or turbine experience a severe speed variation, whereby the speed of the secondary wheel must be synchronized. However, in use in automated gear shift mechanisms it is necessary to provide a separate separating clutch to guarantee a safe interruption of the power flow during shifting operations. In addition the hydrodynamic clutch is solidly integrated in the overall concept of the transmission component and thus not freely exchangeable, since this requires an adaptation of the surroundings.

The invention is therefore based on the object of further developing a multifunctional system, particularly combined drive and brake system of the initially named type, in such a way that it can be employed regardless of the kind of transmission component—automated gear shift mechanisms or automatic transmissions. In particular attention is to be paid to the realization of a starting procedure that is as free of wear and tear as possible regardless of the duration of the state of increased slippage. The multifunctional system itself should thereby be characterizable by a low constructive and control mechanism technology expenditure and be easily integrable in a drive system or in a power transmission unit, for example in the form of a transmission component, whereby the continuously increasing requirements for a small overall length are to be taken into account and integrability should be given regardless of the remaining gear surroundings. An additional aspect of the invention consists in the making possible a certain guarantee of the interruption of the power flow during the shifting operation.

The invention's solution is characterized by the features of Claims 1 and 16. Advantageous designs are described in the dependent claims.

According to the invention a modular constructed multifunctional system, particularly a combined drive, brake and power transfer system comprises an input and an output, a drive element arranged in between in the form of a hydrodynamic element with at least one primary blade wheel and a secondary blade wheel., i.e. in the form of a hydrodynamic clutch, a brake device assigned to a blade wheel as well as a switchable coupling for bridging of the hydrodynamic element, i.e. by-passing of the hydrodynamic power branch in the form of a running friction coupling. The drive element, i.e. the hydrodynamic element has a drive side and a driven side. The driven side of the drive element, i.e. of the hydrodynamic coupling, is connected with the output of the multifunctional or drive unit. According to the invention a free wheel is further provided between the secondary blade wheel, i.e. the driven side of the drive element and the output of the multifunctional unit. The free wheel as a directional switched coupling essentially makes the two following operating states possible:

1. If the speed on the drive side of the drive element, i.e. the secondary wheel is equal to that of the output of the modular constructed multifunctional system, a torque of the secondary wheel is transferred to the output of the modular constructed multifunctional system.

2. If the speed of the secondary wheel, i.e. of the driven side of the drive element is less that at the output of the drive unit no torque is transferred via the secondary wheel to the output, the secondary wheel runs free.

The components drive element, brake device and free wheel are combined into one component, which combined with the switchable coupling forms the multifunctional system. This modular unit forms a first module. The second module is formed by the switchable coupling.

Along with the realization of a nearly wear-and-tear-free starting procedure, the solution of the invention offers the advantage that during the shifting operation the hydrodynamic element does not have to be emptied and also no additional separating clutch is required for power interruption. The uncoupling of the input, which as a rule forms the transmission primary shaft, from the subordinate switch steps occurs solely via the free wheel and therewith secures the function of the synchronizing device in the gear shift mechanism. Constructively the modular unit can be manufactured from the drive element, brake device, free wheel as a pre-assembled modular component, handled and integrated in a transmission component between switchable coupling and switch steps. For this purpose the first module made of drive element, brake device, free wheel and output has two interfaces for coupling with the switchable coupling. The switchable coupling as the second module can thereby under consideration of the connection dimensions be incorporated directly or via adapter elements with a multitude of different designed first modules into a multifunctional system. The possibility of random incorporability is supported by the potential oil-side separation of the two parallel switchable transmission elements, since the bridge coupling is designed as a running coupling.

The switchable coupling and the hydrodynamic coupling are connected parallel to each other, but only engaged jointly during lower timed or defined phases, whereby the power flow between the input and the output of the drive unit can be interrupted. This interruptability can occur thereby in use of the drive unit in automated gear shift mechanisms with the mechanical driving gear inserted after the drive unit by means of the switchability of the switchable coupling during simultaneous emptying or already emptied hydrodynamic coupling or in use in automated gear shift mechanisms with mechanical driving gear or post or group-shifting set in shifting between the first two lower gear stages by means of the emptying of the hydrodynamic coupling. Preferably in such a model the driven sides of the hydrodynamic coupling and the switchable coupling are coupled with each other in a torsion-proof manner via the free wheel. The switchable coupling is designed as a running friction coupling. The advantage of this arrangement consists essentially in the fact that only two states must be distinguished with regard to the power transmission from the input of the multifunctional element to the output, whereby the power transmission occurs either purely mechanically via the switchable coupling or hydrodynamically via the hydrodynamic element. By means of the practical activation optimal use can be made of the advantages of the hydrodynamic power transmission for specified drive states. This applies particularly for the starting procedure, which can take place completely free of wear, whereby in all other drive states a complete bypassing of the slippage-prone hydrodynamic coupling is achieved. Beginning at a specified slippage state, which is dependent on the of the hydrodynamic coupling, the bypassing occurs by means of a coupling between the pump gear and the secondary wheel by means of a mechanically switchable coupling. The drive power is transferred to the output by a driving engine connectable to the modular constructed multifunctional system, particularly the input, with only slight losses, caused by the mechanical transmission systems and the necessary auxiliary energy. Since for use in gear shift mechanisms, particularly synchronized gear shift mechanisms in the change between two gear stages the connection between the driving engine and the driven end as a rule should be separated, this task is assigned to the switchable coupling.

By means of the design of the switchable coupling as a running friction coupling the higher coefficients of friction of these couplings can be used. This also applies for the design of the brake device as a running friction brake.

Each module—switchable coupling and structural unit of the brake device, free wheel and hydrodynamic components—is to be allocated its own housing part, which with the other housing parts forms the total housing. In the process the combination of the hydrodynamic coupling, brake device and free wheel components takes place in a common housing or housing part.

The commonly available housing can be formed by

1. the housing of the hydrodynamic element, particularly the hydrodynamic coupling or

2. by a separate housing.

Also conceivable in the latter case for example is the construction of the housing either alone by the transmission component that can be coupled with the drive unit or by the two elements connecting to the drive unit.

The provided device for optional locking of the secondary wheel in the form of the brake device makes it possible to operate the hydrodynamic element as a complete hydrodynamic retarder as well, thus making possible a wearproof brake device. A separate hydrodynamic brake device, which finds application particularly in commercial vehicles, can be omitted. The ventilation losses of the retarder are in comparison to conventional retarders very slight. The device for locking or for coupling of the secondary wheel to the housing is, in the simplest case, designed as a brake device, preferably in disk brake style. This becomes operative on the driven end the of the hydrodynamic coupling, i.e., on the secondary wheel. The connection of the braking element on the secondary wheel occurs between the secondary wheel and the free wheel. With engaged gear and closed braking element it is possible in especially advantageous manner to avoid a movement of the vehicle contrary to the desired travel direction, i.e. particularly rolling back of the vehicle at inclines. The brake device further makes possible a speedy reduction of the engine speed during upshifting operations and therewith shortens the duration of tractive force interruption with automated gear shift mechanisms.

The drive unit designed according to the invention builds very small, particularly in axial direction, and thus has only slight influence on the overall length during integration into a transmission component, particularly into an automated gear shift mechanism. The structural unit made up of hydrodynamic coupling, free wheel and brake device can be offered on the market and delivered pre-assembled as a modular unit. Integration into a connection unit occurs then non-positively and/or positively, for example by plugging the modular unit onto a primary shaft of the connection element, particularly from post shifting stages of a transmission component or the realization of an axle-hub connection between the output of the drive unit and the input of the connection unit, whereby the primary shaft of the connection unit can simultaneously form the output shaft of the drive unit in assembled state. The combination with a switchable coupling occurs in the same fashion. There is also the option of pre-assembling and handling both modules jointly as a multifunctional unit.

The torsion-proof connection between the drive sides of the hydrodynamic element, particularly of the hydrodynamic coupling behind the free wheel and the switchable coupling above the two interfaces will occur thereby detachably with regard to the assembly. The connection itself can occur positively or non-positively. The concrete selection of the connection type occurs in correspondence to the requirements of the application case.

Regarding the spatial arrangement of the individual components of the hydrodynamic coupling, viewed in axial direction from the input of the modular constructed multifunctional system to the output of the modular constructed multifunctional system essentially the two following possibilities exist:

1. Arrangement of the primary wheel of the hydrodynamic coupling between the switchable coupling and the secondary wheel of the hydrodynamic coupling

2. Arrangement of the secondary wheel of the hydrodynamic coupling between the switchable coupling and the primary wheel of the hydrodynamic coupling

Under a further aspect of the invention the possibility exists of integrating a device for shock absorption, particularly a torsional shock absorber as additional components into the drive unit. The torsional shock absorber can be functionally arranged either at the drive side, i.e. the input, whereby this design is especially advantageous, or that the driven side, i.e. at the output, whereby with regard to the spatial arrangement viewed between the arrangement of the torsional shock absorber in fitting position it can be differentiated

a) spatially before the hydrodynamic coupling and before the switchable coupling or

b) spatially before the hydrodynamic coupling and after the switchable coupling or

c) spatially after the hydrodynamic coupling.

As per a further development of the multifunctional system designed according to the invention, a separate operating fluid and/or control fluid and/or lubrication system is assigned to the first module, which is formed by the structural unit made up of hydrodynamic coupling, brake device and free wheel, resulting in a completely self-sufficient unit with regard to incorporability with switchable couplings and subsequently inserted driving gear differing in design or execution.

The operation of both elements—brake device and switchable coupling—of the modular constructed multifunctional unit occurs with auxiliary energy, for example pneumatic or hydraulic or electric or a combination of them. In the process different auxiliary energies or the same can be useful for operation of the brake device and switchable coupling elements. As per an especially advantageous design the operation of at least the switchable couple, preferably however of both elements, occurs preferably with the same auxiliary energy, which is provided for post-shifting stages, i.e. by means of which a change in gear stage is achievable. This solution also offers great advantages from a control engineering standpoint, since the switchable coupling can be allocated with regard to the operation of the connection unit, particularly the shifting stages of the transmission.

The combination of a hydrodynamic coupling, brake device and a free wheel as well as a switchable coupling as well as additionally a torsional shock absorber and the integration into a modular component makes it possible to create a multifunctional driving component with low component space requirements, particularly for use in vehicles.

The invention's solution will be explained in the following using figures. The figures represent the following:

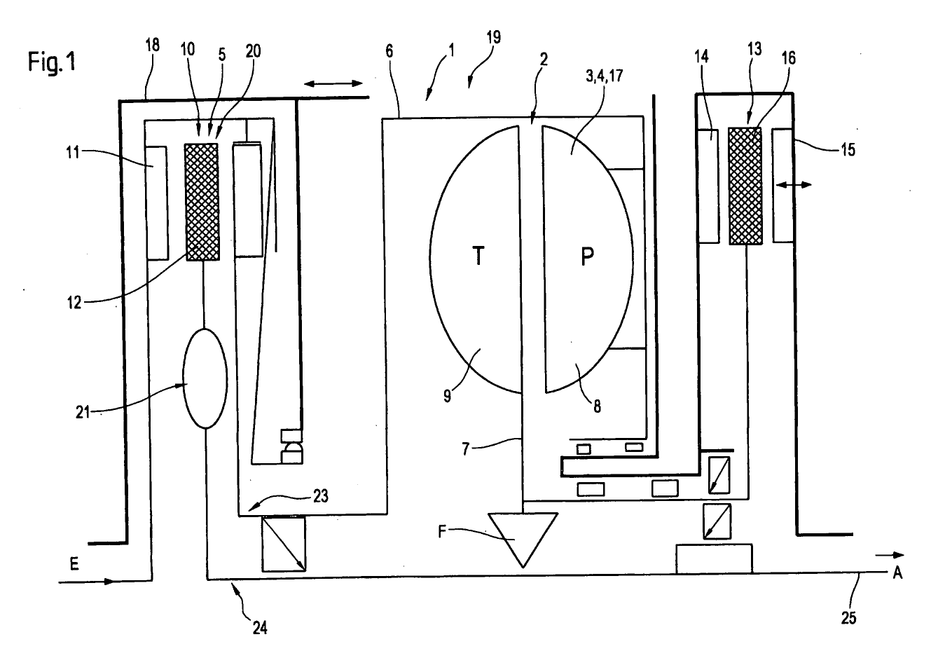

FIG. 1 shows in diagrammatic representation the fundamental structure of a multifunctional system designed according to the invention;

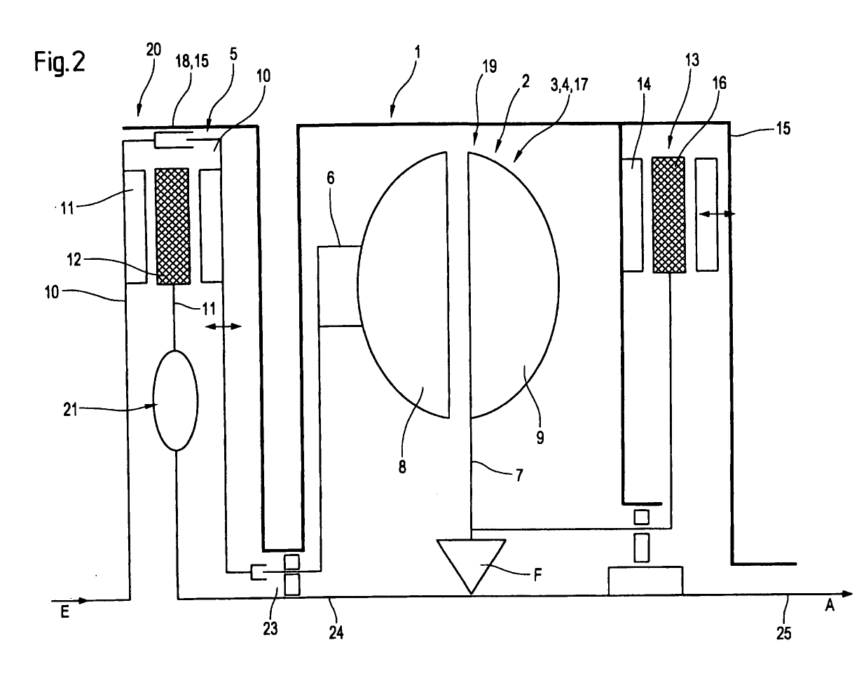

FIG. 2 shows a as per FIG. 1 with spatially exchanged arrangement of the blade wheels;

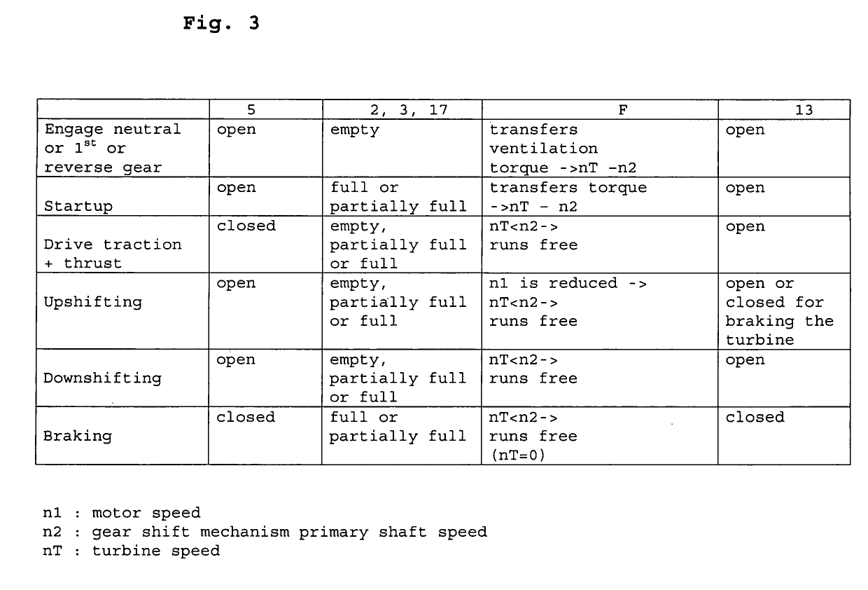

FIG. 3 illustrates different function states using a table

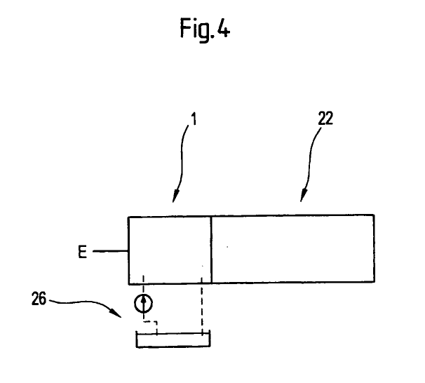

FIG. 4 illustrates in greatly simplified diagrammatic representation the structure of a transmission component with multifunctional unit and a separate operating fluid and/or control fluid and/or lubrication system.

FIG. 1 illustrates in simplified diagrammatic representation the fundamental structure of a modular constructed multifunctional system 1 executed according to the invention, particularly a combined drive, brake and power transfer system. This comprises a drive element 2 in the form of a hydrodynamic element 3, preferably in the form of a hydrodynamic coupling 4 and a switchable coupling 5 for bypassing of the hydrodynamic power branch. The hydrodynamic coupling 4 comprises a drive side 6 that can be coupled with an input E of the modular constructed multifunctional system 1 and a driven side 7 that can be coupled with an output A of the modular constructed multifunctional system 1 and at least one primary wheel 8 acting as an pump gear in traction operation during desired power transmission between input and output via the hydrodynamic element 3 and a secondary wheel 9 acting as a turbine wheel. The designations input and output refer to the direction of lines of force in traction operation during integration of the modular constructed multifunctional system I in a drive system from a driving engine to the driven end of shaft.

The hydrodynamic coupling 4 and the switchable coupling 5 are engage and disengage parallel to one another. The switchable coupling 5 is embodied in the form of a running friction coupling 10. This comprises a coupling input 11 and a coupling output 12, which for example are embodied as clutch disks and can be brought in operative connection with each other at least indirectly by frictional contact, that is either directly or via further disk-shaped intermediate elements which form friction pairings with each other.

A free wheel F is arranged between the secondary wheel 9 or the driven side 7 of the hydrodynamic coupling 4 and the output A. With the free wheel F a multifunctional system 1 is created, which along with achieving positive effects in the starting procedure, also achieves said effects in coupling procedures when used in gear shift mechanisms, particularly automated gear shift mechanisms. Particularly during the change in gear stages excessive wear and tear in the synchronizing devices can be reduced, thus obtaining and even improving the comfort. Further, to implement security toward unintentional rollbacks, for example when starting up on a hill and to utilize the drive element 2 as a hydrodynamic brake device, a brake device 13 is provided. The brake device 13 comprises at least a first stationary disk 14, which is preferably arranged at a housing 15, which is here only indicated on the diagram, and a second disk element 16, which at least indirectly, that is which can be operatively connected either directly or via further interconnected disk elements with the stationary disk 14.

The second disk element 16 is coupled in a torsion-proof manner with the driven side 7, particularly with the secondary wheel 9. By means of providing the brake device 13 at least two mode of operations are achievable with the hydrodynamic element 3—a first mode of operation for power transmission between input E and output A, which has an effect particularly during the startup procedure and describes the function of a hydrodynamic coupling and a second mode of operation for braking, i.e. for utilizing the hydrodynamic element 3 as a retarder 17. To realize the function of the hydrodynamic element 3 as a hydrodynamic retarder 17 the allocation of the function of the stator blade wheel occurs by means of locking against the resting transmission parts, particularly the housing 15 to the secondary blade wheel 9, that is to the turbine wheel acting as a hydrodynamic coupling 4 in the function. The function of a rotor blade wheel of the hydrodynamic retarder 17 is assumed by the primary blade wheel 8, which in operation as a hydrodynamic coupling 4 also acts as an pump gear. The free wheel F represents an optimum opportunity for locking the secondary blade wheel 9 and supporting the housing 15.

The brake device 13, drive element 2, output A are in accordance with the invention additionally combined with the housing 15 into a component 19. That is, the housing 15, which is either one-part or multiple-part in design and the named elements form a first module 19, which can be delivered completely pre-assembled and assembled as well as combined with any switchable couplings 5 or upon integration in transmission components can be arranged between switchable coupling 5 and any designed transmission parts added, switch steps, infinitely variable change-speed gears etc. The second module 20 of the multifunctional system 1 is formed by the switchable coupling 5. Its coupling input 11 is connected in a torsion-proof manner with the input E—depending on the design either directly or via further interconnected elements. The drive side 6 of the drive element 2 forms a first interface 23 to the torsion-proof coupling with the coupling input side 10 of the switchable coupling 5. A second interface 24 is created between the connection of free wheel F and output A and the switchable coupling 5, particularly the coupling output 12. Output A forms an additional third interface 25 to the torsion-proof connection with switch steps or other added transmission elements or transmission parts. The term interface is to be understood functionally and not necessarily as a constructive feature, whereby detachable connections are strived for between the single modules 19 and 20 as well as the connected post shifting stages. The spatial arrangement of the secondary wheel 9 occurs in axial direction viewed between the input and output between switchable coupling 5 and primary wheel 8.

This design makes it possible to create a modular constructed multifunctional system for achieving various functions, that is particularly of the startup procedure of the wear-free coupling procedure and braking procedure upon integration in a transmission component, a gear shift mechanism.

In the modular multifunctional system 1 shown in FIG. 1 the drive element 2 in the form of a hydrodynamic element 3 and the brake device 13 are integrated in a housing 15 and form therewith a module 19. The second module 19 is formed by the switchable coupling 5. Both modules have separate housing parts 15, 18 that can be combined into a complete housing. It is possible to form the housing of the first module 15 by the housing of subsequently inserted switch steps or infinitely variable change-speed gears. This solution makes possible a simple interconnection of the hydrodynamic components as add-on components for realizing different functions for the switchable coupling 5 and the switch steps that are as a rule subsequently inserted during use in vehicles.

Under an further aspect of the invention a torsional shock absorber 21 can additionally be provided. This is functionally allocated either to the drive side, that is the input E of the modular multifunctional system 1, whereby this design is especially advantageous. Another possibility is to functionally allocate the device for shock absorption to the driven side, that is to the output A of the modular multifunctional system 1, whereby regarding the spatial arrangement viewed between the arrangement of the device for shock absorption 21 in fitting position it can be differentiated

a) spatially before the hydrodynamic coupling 4 and the switchable coupling 5, or

b) spatially before the hydrodynamic coupling 4 and after the switchable coupling 5, or

c) spatially after the hydrodynamic coupling 4.

According to an especially advantageous design the brake device 13 is also a running friction brake device. This makes it possible to take advantage of the higher coefficients of friction of dry running transmission units.

FIG. 2 illustrates an alternative design relative to the spatial arrangement of the individual components of the hydrodynamic coupling 4 viewed in axial direction from input E of the modular multifunctional system to the output 4. With this design the spatial arrangement of the primary wheel 8 of the hydrodynamic coupling 4 occurs viewed in axial direction between the switchable coupling 5 and the secondary wheel 9. The operation takes shape similar to the operation described in FIG. 1.

The State Table outlined in FIG. 3 illustrates individual function states and switch variants of the corresponding elements of the modular constructed multifunctional system 1 for the designs according to FIG. 1 and FIG. 2. In the idling setting for engaging the first gear stage or the reverse gear as the case may be the switchable coupling 5 is opened, while the hydrodynamic element 3 is emptied. Via the primary wheel 8 by means of coupling to the input E of the multifunctional system 1 a ventilation torque is generated. The speed n_{secondary} present at the secondary wheel 9, which corresponds to the secondary speed n_{T} of the hydrodynamic element 3, also corresponds to the input speed at the input of the switch steps coupled with the modular multifunctional system 1. In this case a so-called torque of ventilation is transferred via the air current enclosed in the working space by means of circulation.

The starting procedure is characterized by power transmission via the hydrodynamic element, particularly the coupling 4 through the first mode of operation of the hydrodynamic element. In this case the switchable coupling 5 is opened and the hydrodynamic coupling 4 is completely or partially filled. The circulated operating fluid due to the primary blade wheel rotation thereby transfers a torque to the secondary blade wheel 9. The speed of the primary blade wheel 8 corresponds under consideration of the slippage essentially to that of the secondary blade wheel, that is n_{T}=n₂, which corresponds to the speed at the input of the subsequently inserted switch step, that is to the speed n_{A} at the output A of the multifunctional system 1.

During the drive mode of operation, that is in the second operating state, whereby both traction as well as thrust traffic are included, the power transmission occurs as a rule purely mechanically via the switchable coupling 5 by bypassing the hydrodynamic element 3, that is the switchable coupling 5 acts as Switchable Coupling. Said coupling is closed. The hydrodynamic element 3, which in this state does not participate in the power transmission, can thereby either be emptied, partially filled or completely filled. This plays a role particularly when during normal driving operations, that is in traction or thrust operation, braking is to be performed utilizing hydrodynamic forces, that is by engaging a hydrodynamic element. For this purpose the hydrodynamic element is preferably completely emptied, since otherwise a jolt would result upon engagement of the brake device 13 and therewith activation of the hydrodynamic element 3 as a hydrodynamic retarder 17 by means of the quickly building braking torque. When the signal for generating a desired braking torque is given, the brake device 13 in the form of the secondary wheel brake is closed and the working space filled with operating fluid corresponding to the desired torque. During the driving operation the speed of the secondary wheel n_{T} is less than that of the input speed. The secondary blade wheel 9 acting as a turbine wheel runs light.

In the change in gear stages, which characterizes an upshift, the mechanical coupling between the transmission input, that is for example input E of the multifunctional system 1 and the output A is interrupted. The hydrodynamic element 3 is empty, partially or completely filled. The speed of the driving engine coupled with the input E n₁ is reduced and the speed at the secondary blade wheel 9 is lower than the speed at output A or smaller than the than n2 at the switch steps subsequently inserted at the input. Thereby the brake device 13 can be opened or closed for braking the secondary blade wheel 9.

In changes in gear stages which characterize downshifting to a lower gear, the switchable coupling 5 is opened. The hydrodynamic element in the form of the hydrodynamic coupling 4 can be empty, partially or completely filled. Also in this case the speed n_{T} of the secondary blade wheel 9 is lower than the speed n_{A} at the output of the multifunctional system 1. The secondary blade wheel 9 is free from coupling with the output A.

To realize braking procedures the brake device 13 and the switchable coupling 5 are engaged. The hydrodynamic element 3 in the form of the hydrodynamic coupling 4 must be completely or at least partially filled. By means of the free wheel F the secondary blade wheel 9 revolves at a lower speed n_{T} or speed 0 than the output A of the modular multifunctional system 1.

Different switch step combinations are possible in the individual shift procedures upshifting or downshifting. That means, it is possible from a first starting gear to shift either to the next highest or next lowest gear stage or by skipping one or more gear stages to shift to a higher or lower gear.

According to an especially advantageous design in FIG. 4 in allocating the modular constructed multifunctional system 1 to a transmission component 22 a common operating fluid and or lubricant household is provided. The other possibility, not shown here, consists in allocating the modular constructed multifunctional system 1 its own operating fluid and/or lubricant household. With this solution a completely self-sufficient start-up and brake module is created.

List of Reference Symbols

1 modular constructed multifunctional system

2 drive element

3 hydrodynamic element

4 hydrodynamic coupling

5 switchable coupling

6 drive side

7 driven side

8 primary wheel

9 secondary wheel

10 running friction coupling

11 coupling input side

12 coupling output side

13 brake device

14 stationary disk

15 housing

16 disk elements

17 hydrodynamic retarder

18 housing

19 first module

20 second module

21 device for shock absorption

22 operating fluid and/or lubricant household

23 first interface

24 second interface

25 third interface

A output

E input

F free wheel

n_{A} speed at output

n₂ speed at input of a switch step connected after the modular multifunctional system

n₁ speed of the driving engine

n_{T} speed of the secondary wheel

1. Modular constructed multifunctional system (1), particularly a combined drive, brake and power transfer system;
1.1 with an input (E) and an output (A);
1.2 with a drive element (2) in the form of a hydrodynamic element (3), comprising a drive side (6) which can be coupled in a torsion-proof manner to the input (E) and a driven side (7) coupled to the output (A) and at least a primary wheel (8) and a secondary wheel (9);
1.3 with a switchable coupling (5) between the input (E) and the output (A);
1.4 with a brake device (13) for stationary support and braking of the secondary wheel (9) on a housing (15);
1.5 a free wheel (F) arranged between the driven side (7) of the drive element (2) and the output (A);
1.6 the switchable coupling (5) is embodied as a running friction coupling;
1.7 a drive element (2), brake device (13) and free wheel (F) are incorporated into a modular unit (19).

2. Modular constructed multifunctional system (1) according to claim 1, characterized by the fact that the hydrodynamic element (3) and the switchable coupling (4) engage and disengage parallel to each other.

3. Modular constructed multifunctional system (1), characterized by the following features:
3.1 with a device for shock absorption (21);
3.2 the device for shock absorption (21) is spatially and functionally arranged before the switchable coupling (5).

4. Modular constructed multifunctional system (1) according to one of claims 1 or 2, characterized by the following features:
4.1 with a device for shock absorption (21);
4.2 the device for shock absorption (21) is functionally arranged after the switchable coupling (5).

5. Modular constructed multifunctional system (1) according to one of claims 1 through 4, characterized by the fact that the hydrodynamic element (3) is embodied as a hydrodynamic coupling (4).

6. Modular constructed multifunctional system (1) according to one of claims 1 through 5, characterized by the fact that the primary wheel (8) is spatially arranged in axial direction from the input (E) to the output (A) between the switchable coupling (5) and the secondary wheel (9).

7. Modular constructed multifunctional system (1) according to one of claims 1 through 6, characterized by the fact that the secondary wheel (9) is, viewed in axial direction from the input (E) to the output (A), spatially arranged between the switchable coupling (5) and the primary wheel (8).

8. Modular constructed multifunctional system (1) according to one of claims 1 through 7, characterized by the fact that an element of the brake device (13) for braking with the driven side (7) of the hydrodynamic element (3) is pivoted before the free wheel (F).

9. Modular constructed multifunctional system (1) according to claim 8, characterized by the fact that the brake device (13) is embodied as a friction brake device, comprising at least one stationary friction surface bearing element on a housing (15) and a second friction surface bearing element that is coupled in a torsion-proof manner to the driven side (7) of the hydrodynamic element (3)

10. Modular constructed multifunctional system (1) according to claim 9, characterized by the fact that the brake device is embodied as a running friction brake.

11. Modular constructed multifunctional system (I) according to one of claims 1 through 10, characterized by the following features:
11.1 the component made up of drive element (2), the free wheel (F) and the brake device (13) form a first module (19);
11.2 the switchable coupling (5) forms a second module.

12. Modular constructed multifunctional system (1) according to claim 11, characterized by the fact that each of the modules (19, 20) has a separate housing part (15) allocated to it, said separate housing parts which are detachably connected to one another.

13. Modular constructed multifunctional system (1) according to one of claims 11 or 12, characterized by the fact that the housing part (15) of the first module (19) upon use in a transmission component is formed by the housing of the transmission component.

14. Modular constructed multifunctional system (1) according to one of claims 11 through 13, characterized by the fact that the first module (19) has a separate operating fluid and/or control fluid and or lubrication system.

15. Transmission component with a modular constructed multifunctional system (1) as per one of claims 1 through 14 and post-switching stages or infinitely variable change-speed transmission parts which can be coupled in a torsion-proof manner to the output (A).

16. Transmission component according to claim 15, characterized by the fact that it is embodied as an automatic transmission.

17. Transmission component according to claim 15, characterized by the fact that it is embodied as an automated gear shift mechanism. Modular constructed multifunctional system
